(19) United States
(12) Patent Application Publication
(10) Pub. No.: US 2007/0212524 A1
(43) Pub. Date: Sep. 13, 2007

(54) Arrangement For Sealing An Opening In A Vehicle With A Chipping Protector Element

(75) Inventors: Gerit Erbeck, Niederneuching (DE); Werner Paetz, Hofstetten (DE); Hubert Boehm, Greifenberg (DE)

Correspondence Address: ROBERTS, MLOTKOWSKI & HOBBES, P. O. BOX 10064, MCLEAN, VA, 22102-8064, US

(73) Assignee: WEBASTO AG, Stockdorf (DE)

(21) Appl. No.: 10/599,577

(22) PCT Filed: Mar. 22, 2005
(86) PCT No.: PCT/EP05/03011

§ 371 Date: Oct. 2, 2006

(30) Foreign Application Priority Data
Mar. 31, 2004 (DE) 10 2004 015 920.3

(51) Int. Cl. B32B 23/02

(52) U.S. Cl. 428/192

(57) ABSTRACT

This invention relates to an arrangement for closing an opening of a motor vehicle, which is provided with a pane (12), a layer (14) of cement material which acts as a flat shatterproofing element being attached with one side securely to the pane, the other side of the layer of cement material being used to cement at least one attachment part (18, 20, 30, 32, 34) to the pane, the attachment part being a reinforcing element (18) for the pane, a retaining element (303, 32, 34) for connecting the pane to the vehicle body or an element (38) connected to the vehicle body, or a visor.

This invention relates to an arrangement for closing an opening of a motor vehicle with a pane and a shatterproofing element, especially a glass cover for a roof opening.

In order to provide a glass cover of a motor vehicle roof with a shatterproofing function, cementing a shatterproofing film on the underside of the glass pane of the cover is known; the film in its edge area dips for example into the peripheral foam of the pane, by means of which the inside sheet metal of the cover is connected to the pane, see for example DE 43 23 140 A1. When the pane breaks, the shards remain cemented to the shatterproofing film, which in its peripheral area is attached in the peripheral foam of the cover and in this way remains tensioned by the peripheral foam, by which penetration of shards into the vehicle interior or hurling of articles out of the vehicle interior can be prevented.

A similar pane structure is described in DE 101 55 168 A1. Furthermore, similar covers are also described in DE 101 51 156 A1 and DE 102 06 717 A1, in these publications a modification also being described in which the peripheral edge area of the shatterproofing film is turned down and screwed to the inside sheet metal of the cover.

DE 41 05 396 A1 discloses a solar cover for a vehicle roof in which solar cells embedded between two cement layers are attached to the underside of the pane, by which a solar cell film combination is formed which projects in the edge area into the peripheral foam of the cover.

The older German patent application 103 06 957.7 which was not published beforehand furthermore describes a glass cover in which on the underside of the pane a shatterproofing film is cemented which in its edge area projects into the permanently elastic cementing, by means of which a retaining element for linking the cover to the vehicle body is cemented to the pane.

The disadvantage in these known glass covers is that attachment parts such as the frame parts, inside cover sheet metal or visors must be joined to the glass pane with additional cement materials, for example peripheral polyurethane foam or a cement bead, and furthermore for joining the edge area of the shatterproofing film to the peripheral foam or cement or to the inside cover sheet metal complex measures must often be carried out, for example a perforation or a special surface configuration of the edge area of the shatterproofing film.

U.S. Pat. No. 6,675,550 B1 discloses glazing of a building, one layer of ethylene/methacrylic acid copolymers as a shatterproofing element being located between two panes of glass to join them.

U.S. Pat. No. 6,237,306 B1 discloses glazing of a building, one layer of ethylene/methacrylic acid copolymers as a shatterproofing element being cemented to the glass pane and being enclosed together with it in a window frame, on the other side of the shatterproofing element a protective layer which is not enclosed in the frame being cemented.

The object of this invention is to devise an arrangement for closing the opening of a motor vehicle, especially a cover for a roof opening, a shatterproofing element will be provided and still the production of the arrangement should be as economical as possible.

This object is achieved as claimed in the invention by an arrangement as claimed in claim 1. In this connection it is advantageous that there is one layer of cement material which on the one hand itself acts as a flat shatterproofing element, i.e. without an additional film or sheet, and which on the other is used to directly cement a structural attachment part, for example a reinforcing element, a retaining element, or a visor, directly to the pane, especially simple and economical production of the arrangement is enabled.

Preferred configurations of the invention will become apparent from the dependent claims.

The invention is detailed below using the attached drawings.

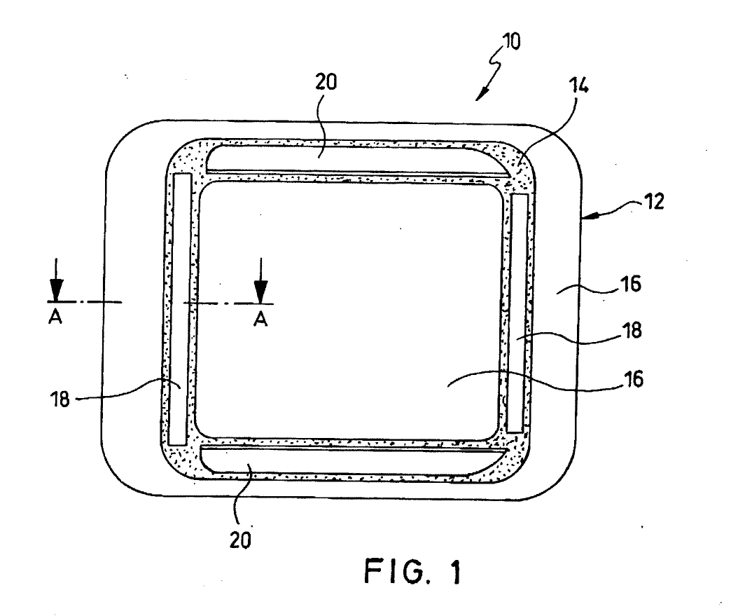

FIG. 1 shows a schematic view of a glass cover as claimed in the invention for a vehicle roof, viewed from the vehicle interior;

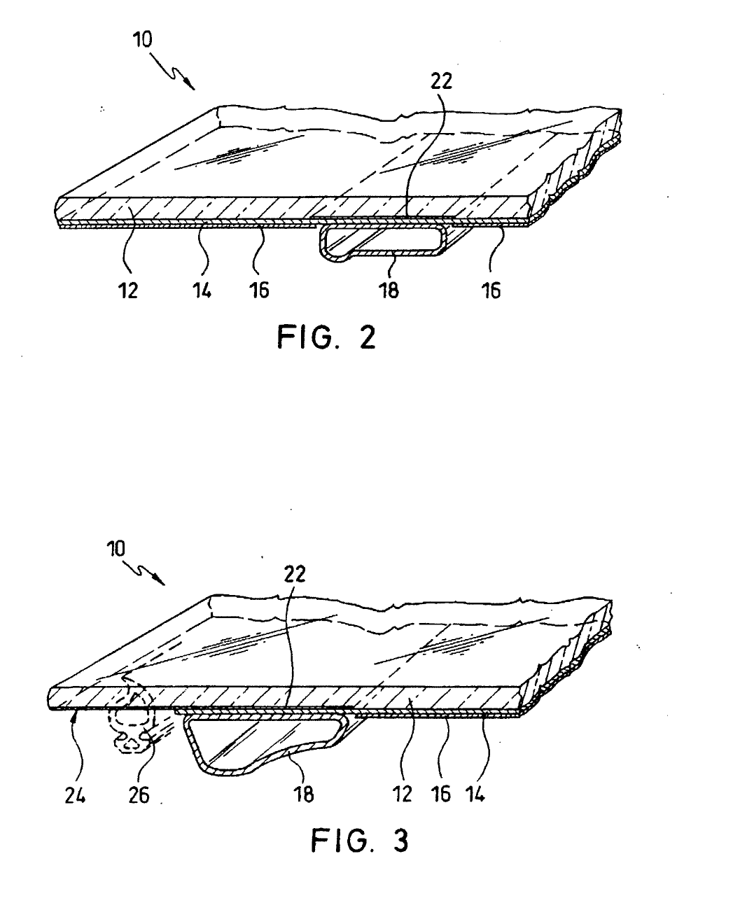

FIG. 2 shows a sectional view along line A-A from FIG. 1, the cover in FIG. 2 being turned by 180° with respect to FIG. 1; and

FIGS. 3-6 show views similar to FIG. 2, but modified embodiments being shown.

FIG. 1 is a schematic of a glass cover 10 for an opening in a vehicle roof in a view from the vehicle interior. The cover 10 comprises an at least partially transparent glass pane 12, with a layer 14 of a flat cement material applied to its underside. The cement material can be for example PU, PVB, EVA or ionomers in sheet or film form. The mechanical properties of the layer 14 of cement material are selected such that when the pane 12 breaks the layer 14 is inherently strong enough to prevent the shards of the pane 12 from penetrating into the vehicle interior or to prevent articles from being hurled out of the vehicle interior through the roof opening to the outside. In other words, the layer 14 of cement material maintains its mechanical integrity even when the pane 12 breaks and without providing a cover layer 16 which is to be detailed later. In particular, the layer 14, when it is securely joined to a frame connected to the vehicle body, also remains tensioned by this frame when the pane 12 breaks even without a cover layer 16.

Furthermore the layer 14 as shown in FIG. 1 is used to cement two reinforcing sections 18 and two retaining angles 20 directly to the underside of the pane 12. Moreover, on the side of the layer 14 of cement material facing the interior of the vehicle, a cover layer 16 is applied which can be formed for example from a PET film, PET sheet, PMMA film or PMMA sheet and can be used for an optical, haptic and/or antiscratch function by the corresponding surface strength or surface configuration or tinting.

A shatterproofing function need not be performed by the cover film 16 since the cement layer 14 alone already has the required strength. The cover film 16 is necessarily relieved in the area of the reinforcing sections 18 and the retaining angles 20 so that the attachment parts 18, 20 directly adjoin the cement layer 14 and thus a nonpositive connection is established.

In the area of the reinforcing sections 18 and the retaining angles 20, on the underside of the glass pane 12 there can be frit imprinting 22.

The retaining angles 20 are used for mechanical joining of the cover 10 to the vehicle body, the retaining angles 20 conventionally being linked to a corresponding positioning mechanism for the cover 10 by means of a screw connection.

In the embodiment as shown in FIG. 1 and FIG. 2, the cement layer 14 extends over the entire surface of the pane 12 up to its immediate edge. The same applies to the cover film 16, except for the areas in which the reinforcing sections 18 and the retaining angles 20 are cemented to the underside of the pane by means of the cement layer 14.

The attachment part or parts can also be a visor instead of a reinforcing element for the pane 12 or a retaining element for connecting the pane 12 to the vehicle body or an element connected to the vehicle body. Preferably the attachment part or parts are the inside cover sheet metal, a reinforcing section or a section which is used as a contact surface for a seal or a cement connection to a body-mounted frame. Preferably the attachment part or parts are located in the edge area of the pane 12, the layer 14 of cement material preferably completely covering at least the central area of the pane 14.

The invention is advantageous insofar as an additional cementing or foaming process for connecting the attachment parts to the glass pane 12 can be omitted, since the attachment parts can be linked in the same process as application of the cement layer 14 acting as the shatterproofing element and of the cover layer 16, by which process time and material can be saved. In this connection, a full-coverage shatterproofing function can be implemented without interruption by attachment parts or retaining means. Furthermore, because the cement layer 14 itself is already acting as a shatterproofing element and is cemented to the corresponding retaining element or frame elements, complex shaping or working of the edge area of a shatterproofing film or sheet according to the prior art for better linkage to the peripheral foam or cementing can be omitted.

FIG. 3 shows a modified embodiment, in the edge area 24 of the pane 12 between the reinforcing section 18 and the edge area the layer 14 of cement material and the cover layer 16 being relieved such that in this area the bottom of the glass pane 12 is exposed. This exposed area 24 is used as the contact surface for a seal 26.

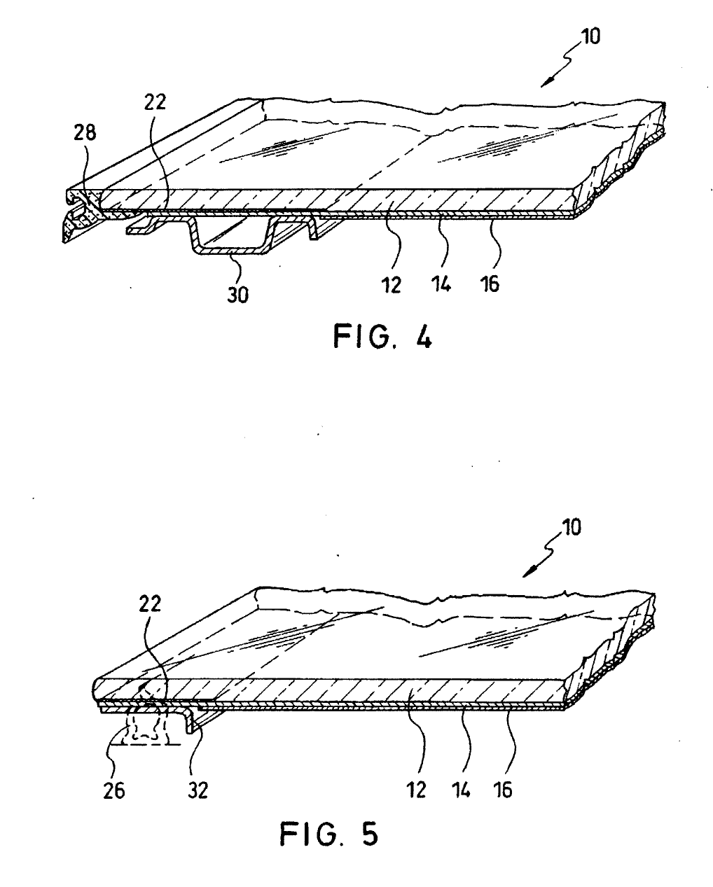

FIG. 4 shows another modified embodiment in which the edge area 24 of the underside of the pane 12 is likewise relieved from the covering by the cement layer 14, but here the recessed area 24 being used for attachment of the peripheral edge foam 28 of the pane 12, for example of polyurethane. Furthermore, in the example from FIG. 4 the cement layer 14 is not used to attach a reinforcing section 18, but to attach the inside cover sheet metal 30 to the underside of the pane 12. The embodiment from FIG. 4 is an adjustable cover, for example of a sliding roof or sliding and lifting roof.

FIG. 5 shows an embodiment in which the cement layer 14 is used for linking the sheet metal section 32 in the edge area of the pane 12 to the underside of the pane 12, the sheet metal profile 32 for its part being used as the contact surface for a seal 26.

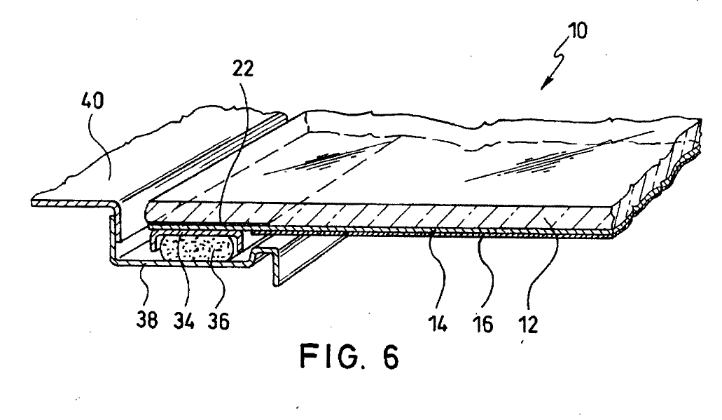

FIG. 6 shows one embodiment in which the glass cover 10 is a so-called glass window element which is cemented into the roof opening of the vehicle. For this purpose, in the edge area of the pane 12 a sheet metal section 34 is cemented by means of a cement layer 14 to the underside of the pane which is used as the working surface for a sealing cement connection 36, by means of which the sheet metal section 34 and thus the pane 12 are cemented to the body-mounted roof frame 38, which for its part is securely connected to the roof skin 40. The cement connection 36 is preferably made as a cement bead.

In all embodiments the material of the cement layer acting as a shatterproofing element can have a tear strength of at least 15 MJ/m³, preferably at least 25 MJ/m³, and a tensile strength of at least 10 MPa, preferably at least 20 MPa, each measured according to US test ASTM D-638. The modulus of elasticity can be at least 50 MPa, preferably at least 150 MPa, measured according to the US test ASTM D-5026.

Preferably the material of the cement layer acting as a shatterproofing element is ethylene/methacrylic acid copolymers. This material is sold under the trademark SentryGlass Plus from DuPont, Wilmington, USA. It is an ionomer material. The layer thickness is preferably between 1.5 and 2.3 mm.

### REFERENCE NUMBER LIST

10 glass cover
12 glass pane
14 cement layer
16 cover film
18 reinforcing section
20 retaining angle
22 frit imprinting
24 edge area of 12 free of 14
26 seal
28 peripheral foam
30 inside cover sheet
32 sheet metal section
34 sheet metal section
36 cement bead
38 roof frame
40 roof skin

1. Arrangement for closing an opening of a motor vehicle, with a pane (12), a layer (14) of cement material which acts as a flat shatterproofing element being attached with one side securely to the pane, the other side of the layer of cement material being used to cement at least one attachment part (18, 20, 30, 32, 34) to the pane, the at least one attachment part being a reinforcing element (18) for the pane, a retaining element (30, 32, 34) for connecting the pane to the vehicle body or an element (38) connected to the vehicle body, or a visor.

2. Arrangement as claimed in claim 1, wherein the at least one attachment part is one of an inside cover sheet metal (30), a reinforcing section (18) or a section (32, 34) which is used as a contact surface for a seal (26) or a cement connection (36) to a body-mounted frame (38).

3. Arrangement as claimed in claim 1, wherein the attachment part (18, 20, 30, 32, 34) is located in the edge area of the pane (12).

4. Arrangement as claimed in claim 1, wherein the layer (14) of cement material completely covers at least the transparent area of the pane (12).

5. Arrangement as claimed in claim 1, wherein the side of the layer (14) of cement material pointing away from the pane (12) in the areas outside the area provided with the attachment part (18, 20, 30, 32, 34) is covered at least in part with a cover film (16).

6. Arrangement as claimed in claim 5, wherein the cover film (16) is made scratchproof, with an embossed surface and/or tinted.

7. Arrangement as claimed in claim 6, wherein the cover film (16) is made from PET, PC, or PMMA.

8. Arrangement as claimed in claim 1, wherein the cement material of the layer (14) is PU, PVB, EVA or ionomers.

9. Arrangement as claimed in claim 1, wherein the cement material of the layer (14) is applied to the pane (12) in sheet form or film form.

10. Arrangement as claimed in claim 1, wherein the pane (12) is a pane of transparent or partially transparent glass.

11. Arrangement as claimed in claim 1, wherein the layer (14) of cement material toward the edge of the pane (12) does not extend beyond the position of the attachment part (18, 30, 32, 34).

12. Arrangement as claimed claim 1, wherein the area (24) between the attachment part (18) and the edge of the pane (12) is used as a contact surface for a seal (26).

13. Arrangement as claimed in claim 1, wherein the arrangement is a cover (10) and the opening is a roof opening.

14. Arrangement as claimed in claim 13, wherein the cover (10) is adjustable and the attachment part is a retaining element (20, 30) which is connected to the positioning mechanism.

15. Arrangement as claimed in claim 1, wherein the attachment part is a retaining element (34) which is tightly cemented into the roof frame (38).

16. Arrangement as claimed in claim 1, wherein the pane (12) in the area of the attachment part (18, 30, 32, 34) is imprinted with a frit (22).

17. Arrangement as claimed in claim 8, wherein the cement material of the layer (14) is a material consisting of ethylene/methacrylic acid copolymers.

18. Arrangement as claimed in claim 1, wherein the cement material of the layer (14) has a tear strength of at least 15 MJ/m³, preferably at least 25 MJ/m³.

19. Arrangement as claimed in claim 1, wherein the cement material of the layer (14) has a tensile strength of at least 10 MPa, preferably at least 20 MPa.

20. Arrangement as claimed in claim 1, wherein the cement material of the layer (14) has a modulus of elasticity of at least 50 MPa, preferably at least 150 MPa.
